(19) United States
(12) Patent Application Publication
(10) Pub. No.: US 2015/0081589 A1
(43) Pub. Date: Mar. 19, 2015

(54) ASSET-BACKED TOKEN PROCESSING WITH ENHANCED PRIVATE-CREDIT EXCHANGE APPARATUS

(71) Applicant: Auden RovelleQuartz, Caledonia, WI (US)

(72) Inventor: Auden RovelleQuartz, Caledonia, WI (US)

(21) Appl. No.: 13/952,182

(22) Filed: Jul. 26, 2013

Related U.S. Application Data
(60) Provisional application No. 61/676,309, filed on Jul. 26, 2012.

(51) Int. Cl. G06Q 40/04

(52) U.S. Cl. CPC G06Q 40/04; G06Q 40/06
USPC 705/36 R

(57) ABSTRACT

An apparatus configured with software that enable participants: to generate tokens which can function as a common exchange medium, by means of remitting assets into an asset-pool; to use tokens to redeem assets from the asset-pool; and to exchange other assets for assets in the asset-pool.

### BACKGROUND OF THE INVENTION

The present invention relates to computer hardware configured to create, and to manage the lifecycle of, tradable tokens that are fully backed by a market-driven pool of a plurality of asset types.

There are millions of qualified people able and willing to work, but who are unemployed largely due to macro-economic conditions relating to access to cash and credit. Many of them are people who would also, directly or indirectly, demand the labor of other qualified people. Even in periods of economic boom cycles there are often people who would be interested in providing more labor output, if their clients had more access to capital and would exchange it for the additional labor. Access to traditional capital is often a constraint to productive labor output.

There are several long-standing philosophical debates over the positions of power that labor and capital have with respect for each other. An objective assessment of history and of current conditions may lead a person to conclude that labor interests are in a subordinate position of power with respect to capital interests, and that the interests of capital usually win out over the interests of workers—in other words that power is typically used (perhaps predictably) for the benefit of the holders of capital. A healthier system would be one where labor itself is viewed as, and functions as, a viable form of capital.

A community reaches higher and broader levels of integration when all right. Every person who wants to work, where there is demand for their labor, should be able to work, even if conventional access to traditional capital is restricted.

Community integration is an enabler of a peaceful and stable democracy. Integrated participation in the economic affairs of a community links an individual's interests to the well being of that community. One key characteristic of an economy exhibiting healthy degree of community integration is that the micro-economic interests of individual market participants are positively correlated to the macro-economic interests of the aggregate community.

That ideal can be attained by creating a freely accessible and innovative form of capital based on a time-standard, where the value of generated tokens is grounded on a time-based reference.

Using a time-standard as the basis for an innovative form of capital is desirable, because time by its very nature is a common reference across all human groups, cultures and societies. Time provides a natural and common frame of reference. For everyone on earth, time can be safely assumed to be constant, non-inflatable, non-contractionary, non-hoardable, non-manipulatable, and impartial to any group.

Underpinning fundamental concepts of perceived value is the notion of human existence itself, since any concept of value is entirely irrelevant in the absence of an existence to be able to appreciate that value. Human existence is measured in units of time, and time is a communal, universally accessible and equitably distributed commodity. The richest man on earth is not able to buy more time than the poorest person on the planet, in the sense that they both have “the same 24 hours” each and every day, and time passes.

An economic system that harnesses those facts and makes good use of those properties of time can be the foundation of a free and fair market that inherently incorporates robust principles of economic justice for its participants. There are significant economic justice principles that are facilitated and promoted by linking economic relations between parties to common references of time.

Free-market voluntary worker cooperatives that are enabled by a time-based economic system can be an effective mechanism to rectify imbalances that currently exist between labor and traditional forms of capital. That is because under such a system, labor-time itself becomes a form of capital, and because the time-based standard provides effective mechanisms against unjust inaccessibility to credit and capital (since ultimately everyone has time), and against unjust economic disparity (since time is universally equally distributed and limited).

Another economic justice aspect of a time-based system is that since the value reference is time-based, the promotion of a highly skilled and highly productive workforce is in the direct interest of token holders. If every person is highly skilled and highly productive, then the tokens are worth much more than if every person were less productive and lower-skilled. Therefore, the richer a person is in terms of tokens held, the more incentive they have to support policies that increase the education, training and skills of all people, on a non-exclusionary and non-competitive basis, since tokens—like time—can be generated at an equal rate for every person, and every person, virtually with no discrimination, can be entitled to trade their time for tokens.

In contrast, under a cash-only system, when there is not sufficient access to cash required to support all of the trade that market participants want to engage in, then the relatively scare cash tends to be allocated to the most productive with no necessary link towards enabling capital and credit access to the lesser productive and lesser skilled market participants to enable them to trade amongst themselves, and with no necessary incentive to promote their increased skill and productivity.

Under a universal access system where anyone willing to work can generate tokens on demand, the most productive can trade with the most productive, yet the lesser productive also have an equal access to the credit and capital to trade amongst themselves, and simultaneously the common reference of time provides a strong incentive for the most productive market participants to support policies that increase the productivity and prosperity of the lesser productive market participants—that situation approaches the ideal of high community integration.

One key difference that would be featured in this innovation, is that anyone is empowered to generate capital by pledging labor (i.e., time effectively “becomes like money”), and that is in contrast with the current system where it is possible for there to be participants able and willing to engage in productive labor amongst themselves, but due to cash and credit shortages (where the cash and credit are generated by external parties) the productive workers are idled.

Traditional capital (whether in the form of precious metals, or well-regarded national fiat currencies) is useful to the economic development and progress of a society. However, the near complete monopolization of traditional capitalist power as the primary medium for, and driving force of, economic activity can result in unbalanced and unhealthy economic conditions.

Historically, there have often been vigorous political initiatives to organize workers such that the exchange of capital for labor is more beneficial to the worker. A big problem with some of the approaches used is that they do not solve the capital-versus-labor power inequality and in addition, they often create safe havens for pools of labor inefficiency to thrive in an environment of lessened incentives to increase efficiency.

To address the power inequality between labor and capital, labor should be on a more equal footing with capital. One effective approach to accomplish this is to devise a system where time itself in the form of labor is the basis for a new form of capital.

Accordingly, there is a need for apparatus configured with software that enables participants to generate tokens by remitting assets into an asset-pool, to use tokens to redeem assets from the asset-pool, and to exchange (i.e. replace) assets in the asset-pool with other assets, as described herein.

### BRIEF SUMMARY OF THE INVENTION

The present invention is an apparatus configured with software that enables participants to generate tokens by remitting assets into an asset-pool, to use tokens to redeem assets from the asset-pool, and to exchange (i.e. replace) assets in the asset-pool with other assets. The asset-backed token processing functions described herein are adapted to interface with the trade-credit exchange apparatus described in U.S. Patent Publication No. 2012/0296808 A1, the entirety of which is incorporated herein by reference.

This system generates fungible tokens, as non-fungible assets of a plurality of types are remitted into an asset-pool. The assets within the asset-pool, in aggregate, represent the full backing of all the tokens in existence.

The tokens can be used to redeem assets from the asset-pool. When there are no assets are in the asset-pool there will be no tokens in existence, because when an asset is redeemed from the asset pool, the system destroys the tokens that were generated when that asset was remitted into the asset-pool.

Under system-specified conditions, the system allows participants to bid to replace assets in the asset-pool with other assets, where the bids are denominated in terms of those other assets. For example, if the system determines that one ounce of gold is eligible to be replaced with silver then the participant that offers the most silver for that ounce of gold, will get the gold from the asset-pool, and the silver will replace that ounce of gold in the asset-pool. In that example, that silver now backs the tokens that were previously backed by that one ounce of gold.

Assets that can be within the asset-pool can be categorized as either independent assets, or dependent assets. Distinctions between independent assets and dependent assets can be summarized as follows: on one hand with independent assets, remittances into the asset-pool are done at a fixed rate, while redemptions out of the asset-pool are done at variable bid-driven rates; on the other hand with dependent assets, remittances into the asset pool are done at variable bid-driven rates, while redemptions out of the asset pool are done at a fixed rate. The term “rate” here relates to the number of newly generated tokens per unit of asset, that the participant either receives for remittances or gives for redemptions.

Regarding independent assets: participants are able to remit independent assets into the asset-pool on demand and new tokens are generated as a function of the amount of independent asset remitted; there is not necessarily limit to the amount of new tokens that can be generated via the remittance of independent assets into the asset-pool.

Regarding the dependent assets: they are remitted into the asset-pool by means of competing bids by participants for a fixed number of newly generated tokens, where that fixed number of new tokens is dependent on (i.e., is a function of) the number of tokens generated from remittances of independent assets into the asset-pool, and where the competing bids are denominated in terms of quantities of the dependent assets to be remitted into the asset-pool in exchange for the tokens. Alternatively, said fixed number of newly generated tokens can be generated in defined quantities at defined intervals (i.e., it does not necessarily have to be a function of the number of tokens generated from remittances of independent assets into the asset-pool).

For example, if the system specifies that 1,000 tokens are to be made available for bids in terms of silver, then the participants offering the highest rates of silver per token for those 1,000 newly generated tokens will get the tokens in exchange for the silver, and the redemption rate for silver from the asset-pool is determined from the average winning bid values.

In a preferred embodiment, the digitally pledged labor-time of participants is considered the independent asset-class, and the system generates new tokens in exchange for time-units of pledged labor, in a way that allows for market-driven valuations of the non-fungible labor-time assets.

Labor is not fungible, because given equal time periods, the labor of one person is not necessarily equivalent to the labor of another person. For example, one hour of labor of a skilled surgeon may be worth more than one hour of labor of a restaurant waiter. This system addresses the issue of labor not being fungible, by creating a market-driven mechanism to determine the worth of one person's labor relative to the labor of other persons. That market-driven mechanism is realized by using fungible time-based tokens, which can be generated on demand by any participant that pledges labor. Participants can use the tokens to bid on the pledged labor of other participants, where the minimum bid for pledged labor is equivalent to the number of tokens generated for pledging that labor. As participants redeem the pledged labor the number of token in existence shrink because the tokens that were generated by the pledged labor are extinguished (i.e. are destroyed) as the pledged labor is redeemed.

In the preferred embodiment, although tokens are be generated in equal amounts for any labor, for example the system may issue 125 tokens per hour regardless of whether the pledged labor is of a waiter or of a relatively highly skilled surgeon, there is a natural market mechanism inherent in this system (during the asset redemption process) that allows the market value of labor worth to be determined. In a preferred embodiment this is accomplished by having the “surplus bid amount” go to the worker that pledges the more valuable labor. In that context, the term “surplus bid” relates to any bid amounts over the required minimum bid.

For example, if 100 workers, each of relatively ordinary skills, each were to pledge 40 hours or labor into the system, and if the system generates and issues to each worker 125 tokens per hour of labor pledged into the system, then there would be 500,000 newly generated tokens in existence backed up by 4,000 hours of pledged worker labor. If everyone valued everyone's time equally (since each worker had skill of ordinary demand), then each person would bid only the minimum number of tokens (i.e. 125) per hour, then as each hour of labor gets redeemed, 125 tokens would be destroyed. If on the other hand, one of the worker had skills that were much more than ordinary demand and if the winning bid for an hour of that highly skilled worker was 1,000 tokens, then of that 1,000 tokens, 125 would be destroyed, and the balance of 875 tokens (i.e. the previously mentioned “surplus bid amount”) would be attributed to the account of that highly skilled worker.

In the preferred embodiment, the system generates new tokens to be made available for bid in terms of dependent assets (e.g. metals or agricultural commodities). However, labor-time would still be the value reference, since it is the only independent asset-class. The amount of a dependent asset a person is willing to give in exchange for the auctioned tokens is based on their perception of the value of their assets relative to the average value of pledged labor-time.

In a preferred embodiment, this creates a marketplace where: the independent reference of value is labor-time; where the independent issuance of spendable tokens is based on labor-time; and where the labor-based value of the tokens can be used to help market participants decide how much non-labor assets to remit in exchanged for tokens that are generated to be auctioned off to highest bidders.

In a preferred embodiment the system is also able to replace unredeemed pledged labor with durable assets in a market-driven way. This is done by holding an asset-replacement auction where the labor-time asset can be replaced with a durable one (e.g. metal or other durable commodity).

In addition to being able to use the tokens to redeem the assets in the asset-pool that back-up their existence, the tokens themselves are able to be used as a common exchange medium that participants can use like a currency to buy and sell things of value not in the asset-pool (e.g., goods, services, etc.).

The ability to remit and redeem independent as well as dependent assets into the asset-pool, and the market-driven way that the assets within the asset-pool are able to change over time, are inherent characteristics of the asset-backed token processing apparatus.

Ancillary enhancements to the trade-credit exchange apparatus include but are not necessarily limited to: (1) interfacing to the asset-back token processing functions by enabling private-credit denominated in the tokens, and expanding the trade-credit exchange apparatus to incorporate asset-back token processing functions described herein; (2) giving members the ability to specify other credits, in addition to their own, that they will accept as payment then updating the trade-search engine algorithm to look for resulting path-expansions for greater trade-match possibilities; and (3) giving members the ability to trade differential amounts, e.g., “I will trade 80 units of my private trade-credit for 100 units of your private trade-credit”, then updating the trade-search engine to find value exchange paths amongst any combination of trade requests where each trade request may be of a differential amount. The trade-search engine and value exchange paths may be further understood with reference to U.S. Patent Publication 2012/0296808 A1.

In an embodiment, an asset-backed token processing apparatus includes a controller and a memory coupled to the controller, wherein the memory is configured to store program instructions executable by the controller; wherein, in response to executing the program instructions, the controller is configured to: generate a quantity of fungible tokens at a fixed rate in response to a receipt of a quantity of an asset in a first category of assets from a remitter, wherein the quantity of fungible tokens generated includes a quantity of tokens provided to the remitter and a quantity of fungible tokens available to be auctioned; auction the fungible tokens available to be auctioned in exchange for the remittance of a quantity of an asset in a second category of assets, wherein the remittance rate of the asset in the second category of assets is a variable, bid-driven rate determined by the auction; redeem the remitted quantity of the assets in the first category of assets for fungible tokens at a variable, bid-driven rate, wherein the variable, bid-driven rate at which the remitted assets in the first category of assets are redeemed must be at or above a minimum required rate, wherein a quantity of the fungible tokens used in the redemption of the remitted assets in the first category of assets equal to the minimum required rate are eliminated and any remaining quantity of the fungible tokens used in the redemption of the remitted assets in the first category of assets are provided to the remitter; and redeem the quantity of the remitted assets in the second category of assets for fungible tokens at a rate defined by the average of the one or more variable, bid-driven rates determined by the one or more auctions in which assets in the second category of assets have been remitted, wherein the fungible tokens used in the redemption of the quantity of the remitted assets in the second category of assets are eliminated.

In some examples, the assets in the first category of assets are labor-time assets. In additional examples, the assets in the first category of assets pledged are a quantity of time for which the remitter will provide labor. In further examples, the controller does not limit the remittance of assets in the first category of assets from the remitter. In even further examples, the quantity of fungible tokens available at auction is a function of the quantity of fungible tokens provided to the remitter. In yet even further examples, the quantity of the fungible tokens available at auction is fixed and the quantity of fungible tokens provided to the remitter is fixed. In other examples, the function is a one-to-one ratio. In some examples, the quantity of the assets in the first or second category of assets received at auction may be exchanged for a quantity of an asset in a different category of assets, wherein the exchange rate is a variable, bid-driven rate determined by an exchange auction. In additional examples, the assets in the first category of assets are non-fungible assets and the assets in the second category of assets are fungible assets. Further, some examples further include a third or greater category of assets subject to the same remittance and redemption criteria required for the second category of assets.

As used herein, the term “asset-class” refers to a defined set of independent-assets, where the members of said set of assets are neither necessarily fungible nor equivalent in value to each other, but where a common notational unit is used to define the quantity of any member of said set of assets, and where new tokens are generated as a function of a set of parameters comprising the remitted units (into the asset pool) of any member of said set of assets. For example, an asset-class may be defined as the labor of any individual within a specific group of people; the common notational unit may be “one hour of labor pledged to be performed at client's location within a 10-mile radius of a specified city”; new tokens may be generated as a function of 125 tokens per each notational unit of labor pledged into the asset-pool, regardless of which person pledged the labor. In that example, it is clear that one hour of one person's time is not necessarily equivalent to one hour of someone else's time, so the labor assets of the individuals in the defined group are not fungible, however, a common notational unit is used.

As used herein, the term “asset-pool object” refers to an object containing attributes pertaining to an asset that has been remitted into the asset-pool, including, but not limited to, any one or more of the following, the type of asset remitted, identification as to whether the asset is an independent or a dependent asset, the participant that remitted the asset, and the redemption price (or minimum redemption price) of the asset.

As used herein, the term “backend processor” refers to a computer-processing component that performs an operation that is not seen by a user.

As used herein, the term “business” refers to any participant that may use asset-backed token processing apparatus. The term “business” may encompass individuals, non-profit institutions, governing agencies, and other entities.

As used herein, the term “commodity” refers to any product or service remitted, redeemed, exchanged or acquired within an asset-backed token processing system.

As used herein, the term “common exchange medium” refers to an exchange medium (e.g. cash, barter dollars, gold, etc.) that is fungible and is accepted as payment by members of a defined trade economy (e.g., a country, barter club, etc.).

As used herein, the term “database” includes, but is not limited to, physical memory, temporary or permanent storage of data, object and record attributes, lists, data structures, physical storage components, virtual storage components, and any other manner of storing data known in the art used to perform a function.

As used herein, the term “dependent asset” refers to an asset used in a process where, a calculated number of new tokens is generated and auctioned-off to the winning bidders, where said calculated number of new tokens can be expressed as a function of a set of parameters comprising the quantity of tokens generated from independent asset remittances into the asset-pool, and where the bids, for said calculated number of new tokens, are denominated in terms of units of the dependent asset. The term “dependent asset” may also refer to an asset used in a process where a defined number of new tokens are generated per a defined schedule and auctioned off such that the winning bidders are the bidders that offer to remit the greatest amounts of one or more defined dependent assets into an asset-pool.

As used herein, the term “dependent asset redemption object” refers to an object containing attributes pertaining to the a participant redeeming a dependent asset from the asset-pool, including, but not limited to, the participant redeeming the asset, the asset being redeemed, and the quantity of tokens being used to redeem the asset.

As used herein, the term “dependent asset remittance bid object” refers to an object containing attributes pertaining to a participant's bid to remit a dependent asset into the asset-pool in exchange for newly generated tokens, including, but not limited to, the participant placing the bid for newly generated tokens, the number of newly generated tokens being bid on, and the type and quantity of asset being offered to bid on said number of newly generated tokens.

As used herein, the term “distributed” means that physical and logical components, data recipients, and/or participants may be in a single location or in multiple locations.

As used herein, the term “generated tokens object” refers to an object containing attributes pertaining to the generation of new tokens, including, but not limited to, the number of new tokens being generated, and the type of dependent asset that can be used to bid for those newly generated tokens.

As used herein, the term “holdings account” refers to a ledger maintained by an asset-backed token processing apparatus which contains accountings of a participant's commodity assets, commodity obligations, common exchange media and any other set of, one or more, assets and/or performance obligations.

As used herein, the term “independent asset” refers to an asset within an asset-class, where for any asset within that asset-class, new tokens are generated as a function of a set of parameters comprising the amount of the asset remitted into the asset-pool, and where the assets within that asset-class are not fungible yet can be measured by a common notational unit of account. There is no cap on the amount of new tokens that can be issued into circulation for remitting units of an independent asset into the asset-pool; rather the number of new tokens issued into circulation is defined as a function of a set of variables comprising the amount of independent assets remitted into the asset-pool.

As used herein, the term “independent asset redemption bid object” refers to an object containing attributes pertaining to a participant placing a bid to redeem an independent asset from the asset-pool, including, but not limited to, the participant placing the bid, the asset being bid on, and the quantity of tokens being used to bid on the asset.

As used herein, the term “independent asset remittance object” refers to an object containing attributes pertaining to the remittance of an independent asset into the asset-pool, including, but not limited to, the participant remitting the asset, the type of asset being remitted, and the quantity of the asset being remitted.

As used herein, the term “market transaction object” refers to an object containing attributes pertaining to a participant placing a request for a transaction that does not involve remittance of an asset into the asset-pool, nor redemption of an asset out of the asset-pool, nor replacement of an asset that is in the asset-pool, where those attributes comprise any one or more of the following: the participant placing the request for a transaction, the tokens and/or other assets offered in the transaction, the tokens and/or other assets requested in the transaction.

As used herein, the term “network connection” refers to any software or hardware that allows two or more computers or devices to communicate with one another.

As used herein, the term “object” refers to a data structure that includes data attributes and/or functions.

As used herein, the term “participant” refers to an individual or entity authorized to use an asset-backed token processing apparatus.

As used herein, the term “participant holding object” refers to an object containing attributes and data associated with a specific user, including, but not limited to, any one or more of participant identifying information, balances of common exchange media, assets and obligations. Participant holding objects may also include functions for modifying such attributes.

As used herein, the term “physical storage component” refers to any data storage device, including, but not limited to, computer memory, disks, internal or external hard drives, flash drives, and other memory devices.

As used herein, the term “processor” refers to any hardware component configured with software to perform a calculation, function or operation. As used herein, a processor may also refer to a function that resides on a physical device.

As used herein, the term “redemption object” refers to an object containing attributes pertaining to the redemption of asset-pool assets, including, but not limited to, the asset being redeemed, and the redeemer of asset.

As used herein, the term “replacement asset bid object” refers to an object containing attributes pertaining to a participant's bid to replace an asset in the asset-pool with another asset, including, but not limited to, the participant replacing the asset, the type of asset being replaced, and the amount of the asset being used to replace the asset that is in the asset-pool.

As used herein, the term “replacement asset object” refers to an object containing attributes pertaining to a replacement processor identifying an asset that is available for replacement, including, but not limited to, the type of asset that can be replaced, the amount of the asset that can be replaced, and the assets that can be used to replaced the asset that is in the asset-pool.

As used herein, the term “set of parameters” refers to one, or a plurality of, parameters.

As used herein, the term “third-party” refers to any entity that is not a participant in a trade transaction.

As used herein, the term “trade-credit exchange apparatus” refers to an apparatus configured with software that enables participants to exchange trade-credit, comprising one or more databases and processing components, which utilizes automated value matching algorithms and trade search engine algorithms to discover and process exchange paths.

As used herein, the term “user interface” refers to any device which may interface with a processor, database or other component of an asset-backed token processing apparatus through any communication method known in the art, including, but not limited to, internet communications, wireless communications, Wide Area Networks, Local Area Networks and any combination thereof.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is an exemplary embodiment of an asset-backed token processing apparatus.

FIG. 2 is an exemplary embodiment of a replacement processor with sub-processing components for an asset-backed token processing apparatus.

FIG. 3 is an exemplary embodiment of an asset-pool processor with sub-processing components for an asset-backed token processing apparatus.

FIG. 4 is an exemplary embodiment of a redemption processor with sub-processing components for an asset-backed token processing apparatus.

FIG. 5 is an exemplary embodiment of a market processor with sub-processing components for an asset-backed token processing apparatus.

FIG. 6a is an exemplary embodiment of an asset redemption process for an asset-backed token processing apparatus.

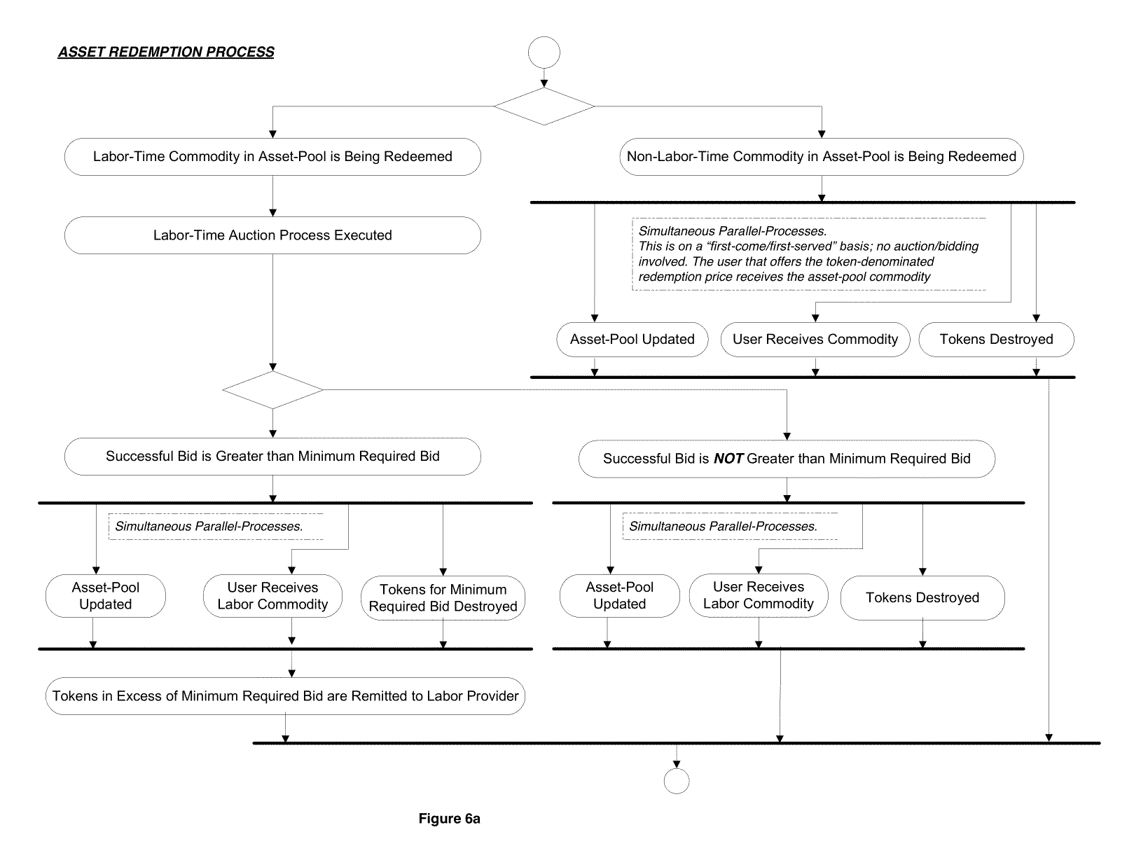

FIG. 6b is an exemplary embodiment of an asset exchange process for an asset-backed token processing apparatus.

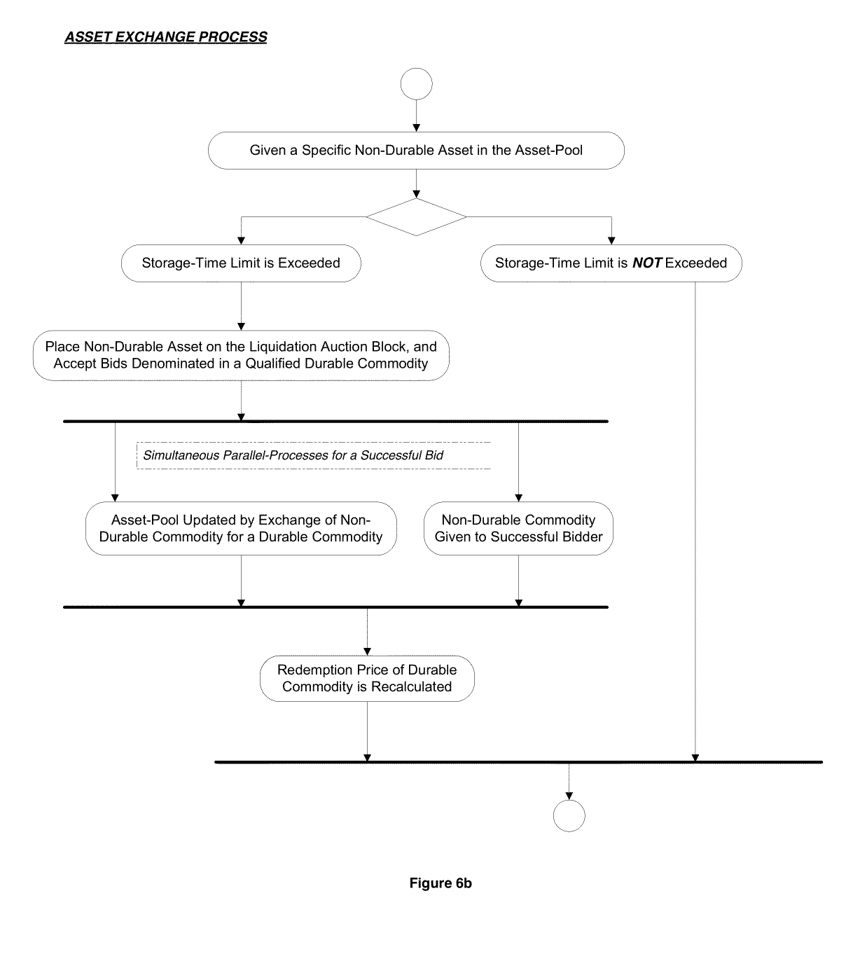

FIG. 6c is an exemplary embodiment of an dependent-asset token-generation process for an asset-backed token processing apparatus.

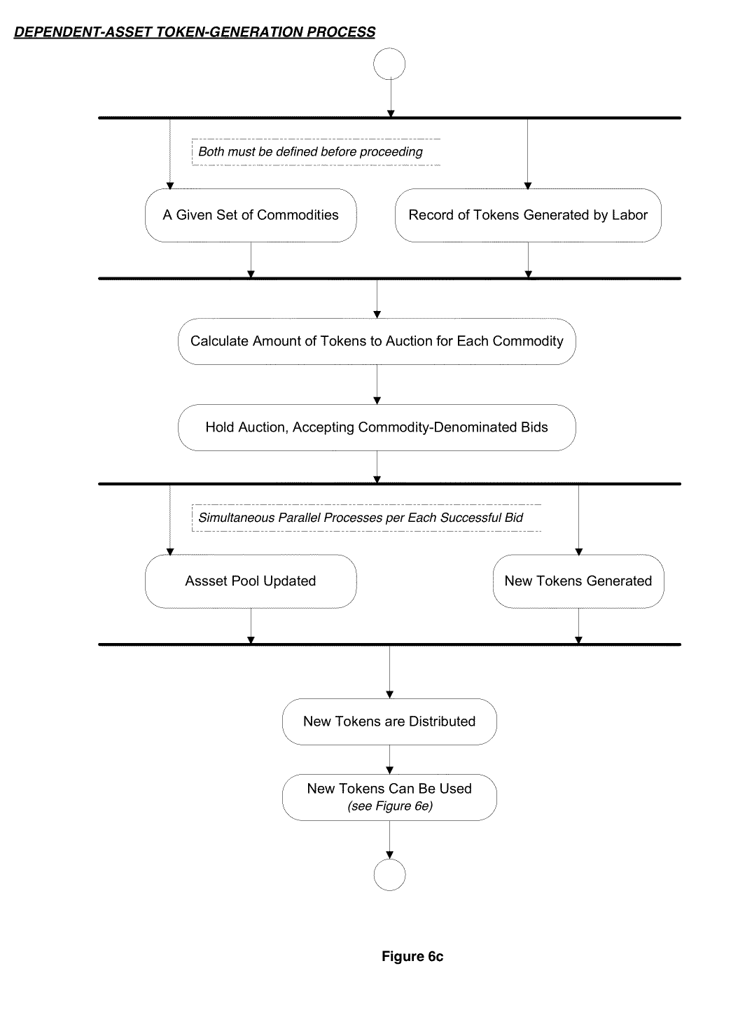

FIG. 6d is an exemplary embodiment of an independent-asset token-generation process for an asset-backed token processing apparatus.

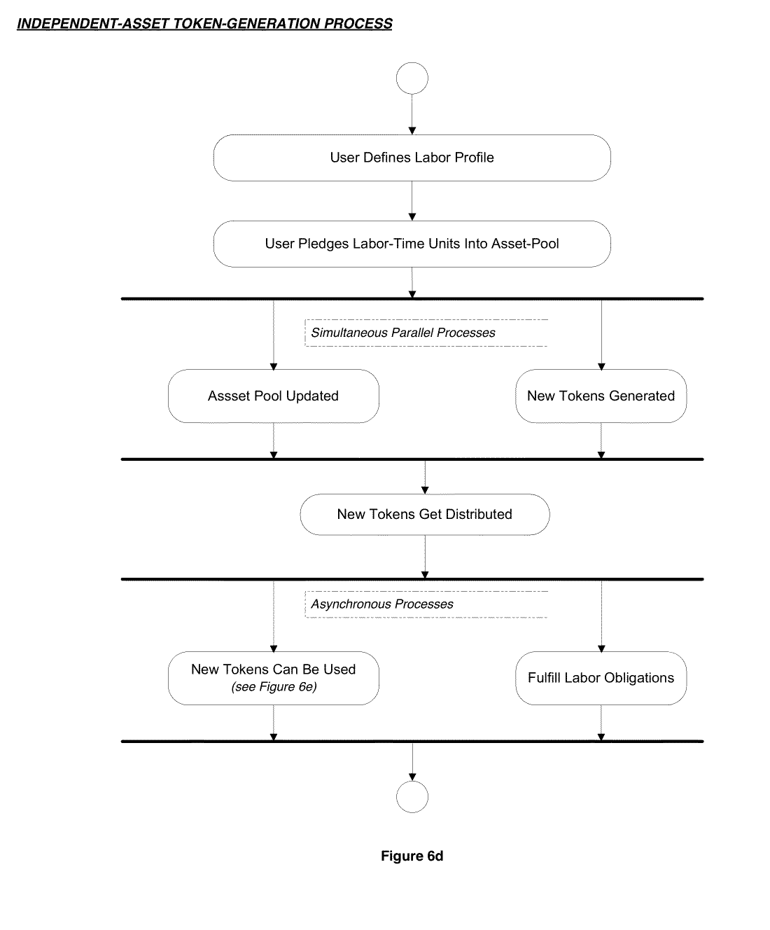

FIG. 6e is a diagram illustrating the options for using tokens with the asset-backed token processing apparatus.

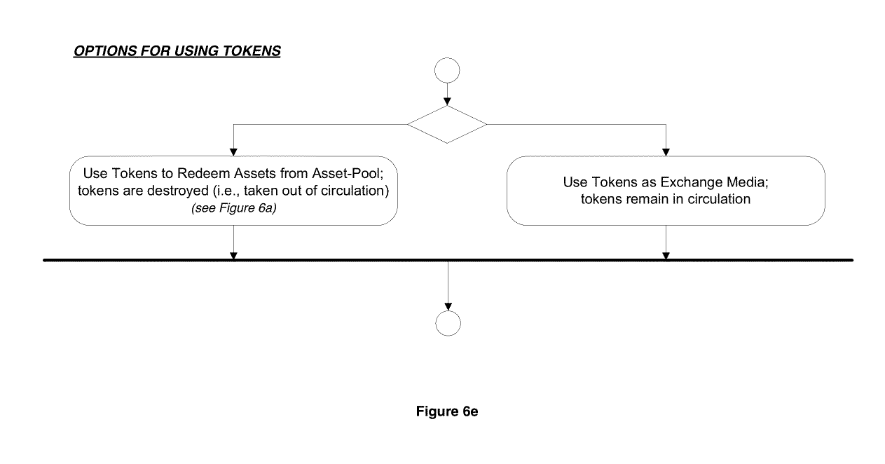

### DETAILED DESCRIPTION OF THE INVENTION

For the purpose of promoting an understanding of the present invention, references are made in the text to exemplary embodiments of an asset-backed token processing apparatus, only some of which are described herein. It should be understood that no limitations on the scope of the invention are intended by describing these exemplary embodiments. One of ordinary skill in the art will readily appreciate that alternate but functionally equivalent structures, hardware components and processes may be used. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

It should be understood that the drawings are not necessarily to scale; instead emphasis has been placed upon illustrating the principles of the invention. In addition, in the embodiments depicted herein, like reference numerals in the various drawings refer to identical or near identical structural elements.

Moreover, the terms “substantially” or “approximately” as used herein may be applied to modify any quantitative representation that could permissibly vary without resulting in a change in the basic function to which it is related.

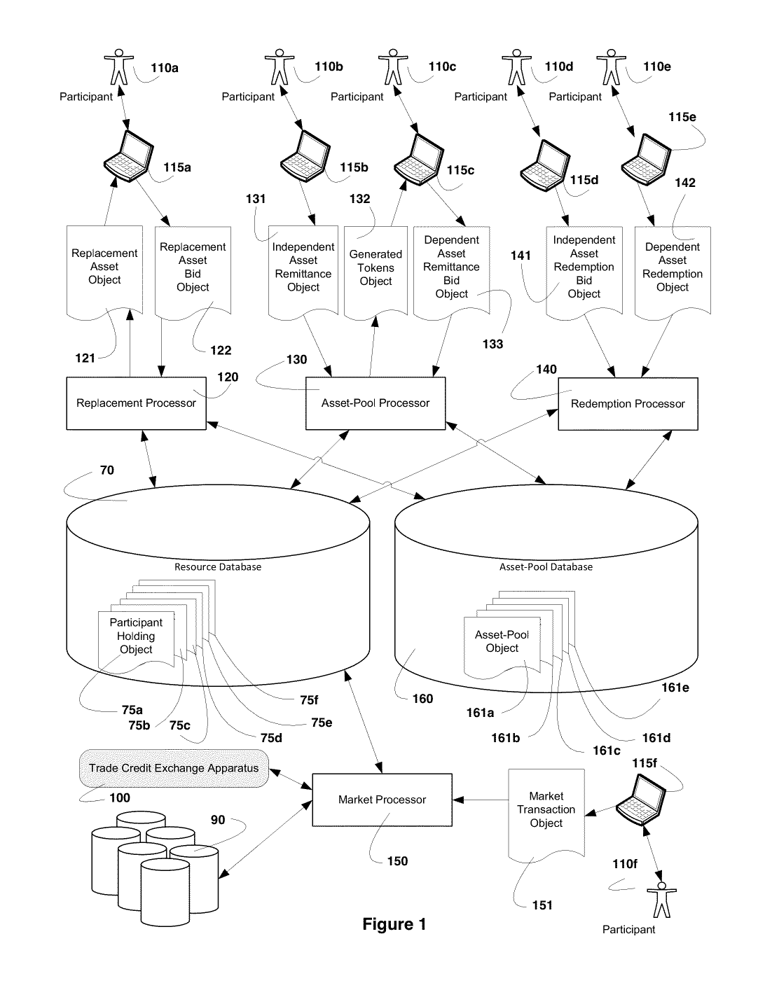

FIG. 1 is an exemplary embodiment of asset-backed token processing apparatus 200. As shown in FIG. 1, asset-backed token processing apparatus 200 contains four main processors (replacement processor 120, asset-pool processor 130, redemption processor 140, and a market processor 150) and two main databases (resource database 70, and asset-pool database 160).

In this embodiment, five distinct participant-roles are defined for interactions involving the asset-pool. A Participant can at different times play any of the five different roles. In any of those five roles, the Participant is doing either one of three things: remitting assets to the asset-pool (two distinct roles), redeeming assets from the asset-pool (two distinct roles), or replacing assets in the asset-pool (one role).

Assets allowed in the asset-pool are classified as either “Independent Assets”, or “Dependent Assets”. An “Independent Asset” is one where new tokens are generated and distributed based on the amount of the asset remitted into the asset-pool. A “Dependent Asset” is an asset used in a process where new tokens are generated and auctioned-off to the highest bidders, where the bids for those new tokens are denominated in terms of units of the “Dependent Asset”. In a preferred embodiment the number of new tokens generated, to be auctioned-off for dependent assets, is based on the number of tokens that were generated from remittances of “Independent Assets” into the asset-pool.

The following provides an example of the relationship between “Independent” and “Dependent” assets: participants' labor-time units are classified as “Independent Assets”, where the unit is defined as one hour of labor of a participant, and where the function for new-token generation is defined as 125 new tokens for each hour of pledged labor-time remitted to the asset-pool. Silver is classified as a “Dependent Asset” where the unit is defined as one gram, and where the formula for the number of newly generated tokens to be auctioned-off is defined as the amount required to maintain a 50% issuance-ratio between tokens issued for Independent Assets and Dependent Assets. In June 100,000 new tokens were issued into circulation based on pledged labor-time being remitted into the asset-pool. So to meet the 50% issuance-ratio criteria, in July 100,000 new tokens are issued and auctioned-off to those offering the most grams of silver for the 100,000 new tokens. In July 67,000 new tokens were issued into circulation based on pledged labor-time being remitted into the asset-pool. So to meet the 50% issuance-ratio criteria, in August 67,000 new tokens are issued and auctioned-off to those offering the most grams of silver for the 67,000 new tokens. In August 223,000 new tokens were issued into circulation based on pledged labor-time being remitted into the asset-pool. So to meet the 50% issuance-ratio criteria, in September 223,000 new tokens are issued and auctioned-off to those offering the most grams of silver for the 223,000 new tokens and so on.

In this embodiment, four distinct processors are defined: an asset-pool processor, a redemption processor, a replacement processor, and a market processor. The previously described five participant-roles interacting with the asset-pool are described as follows: Participant-A: remits “Independent Assets” into the asset-pool; Participant-B: remits “Dependent Assets” into the asset-pool; Participant-C: redeems “Independent Assets” from the asset-pool; Participant-D: redeems “Dependent Assets” from the asset-pool; Participant-E: replaces assets (either “independent” or “dependent” ones) in the asset-pool.

The asset-pool processor is the processor that hosts the processes where new tokens are brought into existence. This processor issues new tokens into circulation, as assets are remitted into the asset-pool. This processor executes two separate processes for remitting assets: one for remitting “Independent Assets” into the asset-pool, and one for remitting “Dependent Assets” into the asset-pool.

Example of a process for remitting “Independent Assets”: per each unit of an independent asset (e.g. for each hour of labor-time), a defined number of new tokens (e.g. 125 tokens) are brought into existence and issued to the participant that remits the asset into the asset-pool. The minimum redemption price for an independent asset is defined to be the number of new tokens that are brought into existence per unit of that independent asset (e.g. 125 tokens is defined as the minimum redemption price for one hour of labor-time).

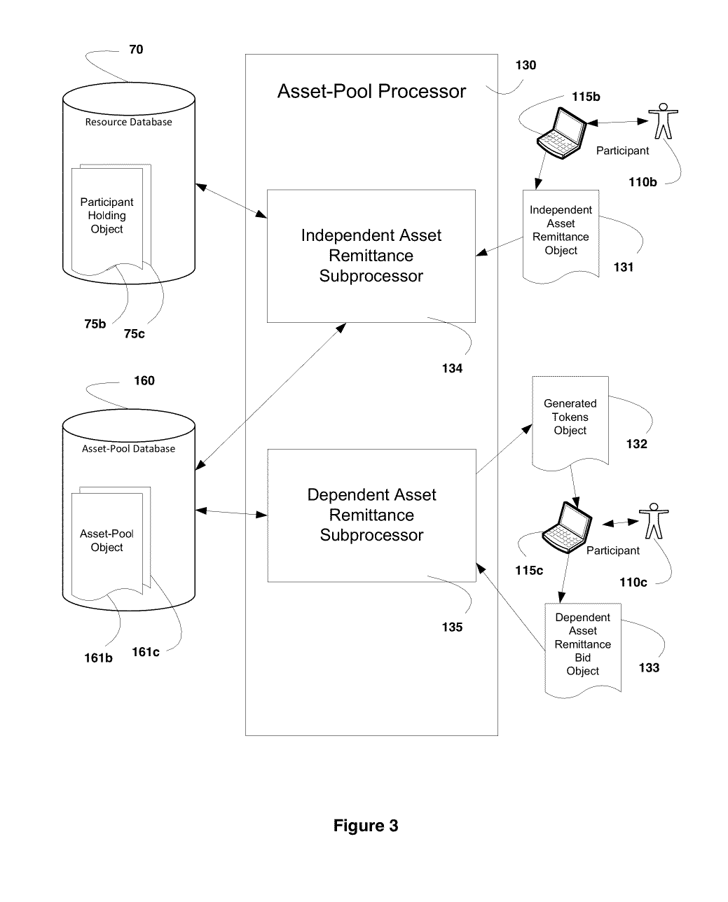

As illustrated in the exemplary embodiment shown in FIG. 3, participant 110b, using interface 115b, generates independent asset remittance object 131 containing properties comprising the type and quantity of the independent asset being remitted. Independent asset remittance subprocessor 134 receives independent asset remittance object 131 and transfers the asset being remitted, from participant's 110b holdings account into asset-pool database 160, by updating participant holding object 75b and asset-pool database 160 appropriately. Independent asset remittance subprocessor 134 also generates a corresponding amount of new tokens and transfers them to participant's 110b holdings account by updating participant holding object 75b appropriately.

Example of a process for remitting “Dependent Assets”: a quantity of new tokens are brought into existence and auctioned-off, where the bids are defined in terms of amounts of the dependent assets, and where the quantity of new tokens brought into existence is based on the number of new tokens generated from remittances of independent assets into the asset-pool. Redemption prices for the dependent assets are calculated and updated based on successful remittance bids processed. For each dependent asset in the asset-pool, the redemption price is determined, such that the amount of tokens required to redeem all of that asset in the asset-pool is equivalent to the total number of new tokens that were issued into circulation based on remitting that asset into the asset-pool.

The asset-pool processor receives information from the resource database that enables the processor to qualify a participant's remittance request by determining if participant has adequate resources available to remit to the asset pool. Then pending successful qualification this processor also updates: resource database regarding the number of tokens in the participant's account, and resource database regarding the amount of assets and/or liabilities in the participant's account, where those updates are due to assets being remitted to the asset-pool.

As illustrated in the exemplary embodiment shown in FIG. 3, dependent asset remittance subprocessor 135 creates generated tokens object 132, (e.g., derived as a function of the number of tokens generated from remittances of independent assets into asset-pool database 160). Then participant 110c, using user interface 115c, generates dependent asset remittance bid object 133. If dependent asset remittance bid object 133 represents the winning bid for the tokens represented by generated tokens object 132, then dependent asset remittance subprocessor 135 transfers the asset represented by dependent asset remittance bid object 133 from participant's 110d holdings account into asset-pool database 160 by updating participant holding object 75c and asset-pool database 160 appropriately. Dependent asset remittance subprocessor 135 also transfers the newly generated tokens represented by generated tokens object 132 to participant's 110c holdings account by updating participant holding object 75c appropriately.

The redemption processor is the processor that hosts processes for redeeming assets from the asset-pool. This processor only accepts tokens in exchange for the assets being redeemed from the asset-pool Redemption of “Dependent Assets”: The redemption processor executes a process such that, on a first-come-first-served basis, participants that offer the specified redemption-price (in terms of tokens) for the “Dependent Assets” get the assets. The tokens used to redeem “Dependent Assets” are all extinguished (i.e. destroyed, taken out of circulation).

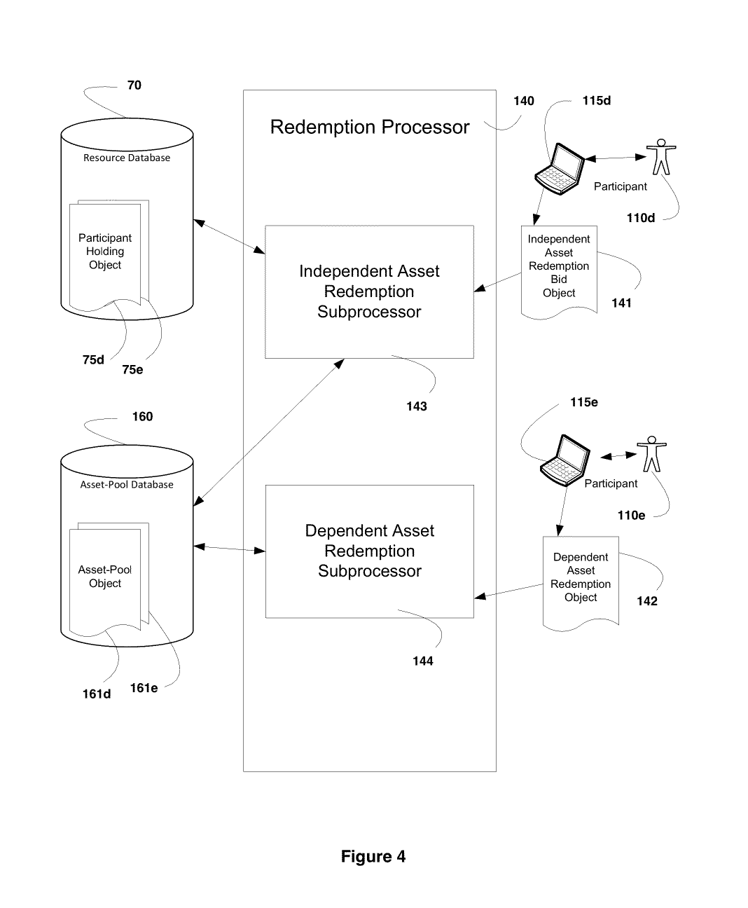

As illustrated in the exemplary embodiment shown in FIG. 4, participant 110e, using interface 115e, places a request to redeem a dependent asset represented by asset-pool object 161e in asset-pool database 160 by generating dependent asset redemption object 142, containing properties comprising the type of the dependent asset being redeemed. Dependent asset redemption subprocessor 144 receives dependent asset redemption bid object 142 and transfers the asset represented by asset-pool object 161d, from asset-pool database 160 into participant's 110d holdings account, by updating participant holding object 75d and asset-pool database 160 appropriately. Dependent asset redemption subprocessor 144 also updates participant holding object 75d appropriately by decrementing participant's 110d holdings account by the number of tokens offered in the bid, and destroys those tokens (i.e. those tokens are then taken out of circulation, extinguished and are no longer existent).

Redemption of “Independent Assets”: The redemption processor executes bidding processes on “Independent Assets”, where the minimum acceptable bid is defined to be the redemption-price of the asset being redeemed. The successful bidder gets the “Independent Asset”, and of the successful bid amount, the quantity of tokens equivalent to the redemption-price of the “Independent Asset” is extinguished (i.e. destroyed, taken out of circulation), and the tokens in excess of that redemption-price are given to the person(s) that remitted the asset into the asset-pool.

The redemption processor receives information from the Resource Database that enables the processor to qualify a participant's asset-redemption request by determining if participant has adequate resources available to redeem the asset from the asset-pool. Then pending successful qualification this processor also updates: Resource Database regarding the number of tokens in the Participant's account, and Resource Database regarding the amount of assets in the Participant's account, where those updates are due to assets being redeemed from the asset-pool.

As illustrated in the exemplary embodiment shown in FIG. 4, participant 110d, using interface 115d, places a bid to redeem an independent asset represented by asset-pool object 161d in asset-pool database 160 by generating independent asset redemption bid object 141, containing properties comprising the type of the independent asset being bid on and the quantity of tokens offered for the independent asset being bid on. Independent asset redemption subprocessor 143 receives independent asset redemption bid object 141 and verifies that the number of tokens offered is at least equal to the minimum redemption price associated with asset-pool object 161d.

If the minimum redemption price is what is offered by the bid represented by independent asset redemption bid object 141, and if that bid is the winning bid, then independent asset redemption subprocessor 143 transfers the asset represented by asset-pool object 161d, from asset-pool database 160 into participant's 110d holdings account, by updating participant holding object 75d and asset-pool database 160 appropriately. Independent asset redemption subprocessor 143 also updates participant holding object 75d appropriately, by decrementing participant's 110d holdings account by the number of tokens offered in the bid, and destroys those tokens (i.e. those tokens are then taken out of circulation, extinguished and are no longer existent).

If the minimum redemption price is less than what is offered by the bid represented by independent asset redemption bid object 141, and if that bid is the winning bid, then independent asset redemption subprocessor 143 transfers the asset represented by asset-pool object 161d, from asset-pool database 160 into participant's 110d holdings account, by updating participant holding object 75d and asset-pool database 160 appropriately. Independent asset redemption subprocessor 143 also updates participant holding object 75d appropriately by decrementing participant's 110d holdings account by the number of tokens offered in the bid. Regarding the number of tokens offered by the bid, independent asset redemption subprocessor 143 also destroys the number of tokens corresponding to said minimum redemption price (i.e. those tokens are then taken out of circulation, extinguished and are no longer existent), and transfers the remaining tokens to holdings account of the participant that remitted the asset represented by asset-pool object 161d into asset-pool database 160.

The replacement processor is the processor that hosts processes for replacing assets in the asset-pool. The processor selects assets to be replaced (e.g. based on a non-durable asset reaching close to its storage time-limit in the asset-pool), and then auctions-off the assets, in a process where bids are denominated in terms of a system-specified asset, with the successful bidder receiving the asset from the asset-pool, in exchange for the system-specified asset he used to place the bid and the system-specified asset is then placed in the asset-pool.

The replacement processor receives information from the Resource Database that enables the processor to qualify a participant's asset-replacement request by determining if participant has adequate resources available to replace the asset from the asset-pool. Then pending successful qualification this processor also updates the Resource Database regarding the quantity of the asset, received from the asset-pool, in the Participant's account, and the Resource Database regarding the amount of the system-specified asset(s), used to replace the asset in the asset-pool, in the Participant's account, where those updates are due to assets being replaced in the asset-pool.

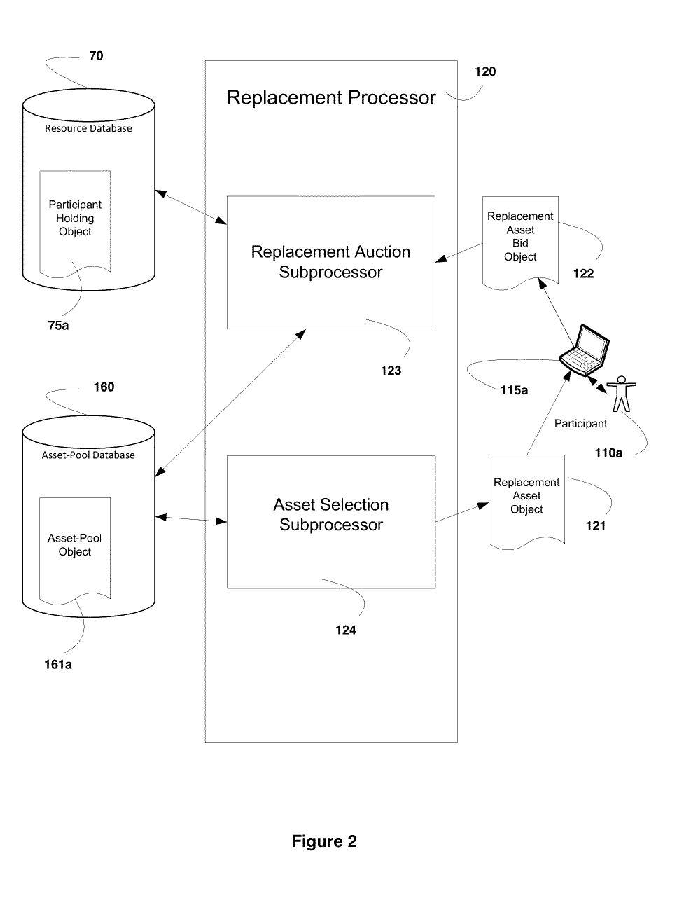

As illustrated in the exemplary embodiment shown in FIG. 2, asset selection subprocessor 124 creates replacement asset object 121 derived from asset-pool object 161a in asset-pool database 160. Then participant 110a, using user interface 115a, generates replacement asset bid object 122. If replacement asset bid object 122 represents the winning bid for asset-pool object 161a, then asset selection subprocessor 124 transfers the asset represented by asset-pool object 161a from asset-pool database 160 and into participant's 110a holdings account by updating participant holding object 75a and asset-pool database 160 appropriately.

Although the tokens can be used to redeem items of value from the asset-pool, the tokens themselves can be used as a common exchange medium, in a preferred embodiment, the tokens would be able to be used within the trade-credit exchange apparatus such that trade-credit can be exchanged for tokens and tokens for trade-credit.

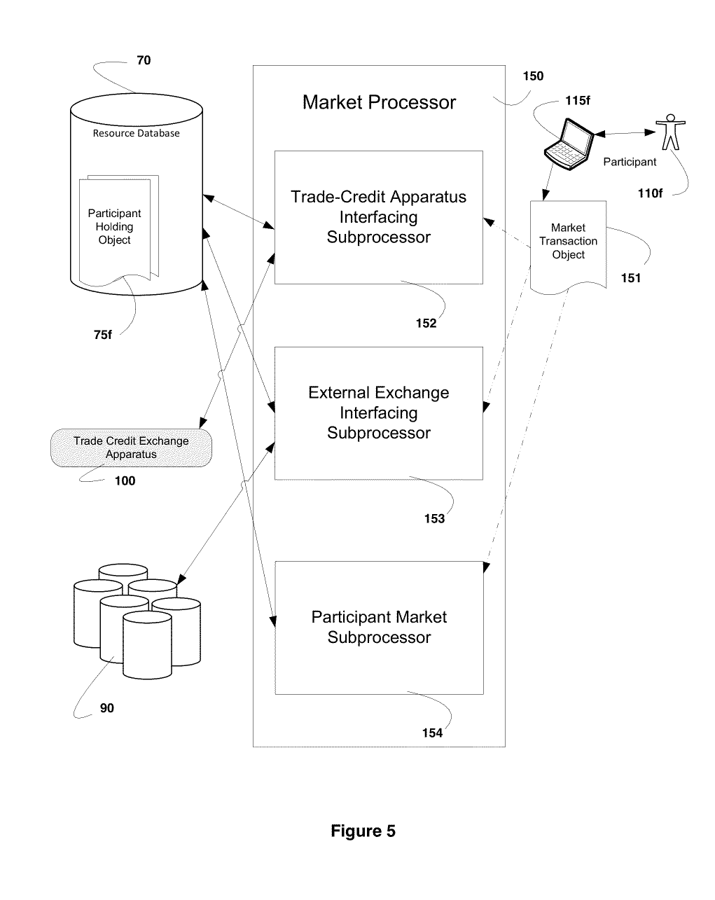

As illustrated in exemplary embodiment shown in FIG. 5, participant 110f, using interface 115f, generates market transaction object 151 containing properties comprising the items offered, the items demanded, the specific marketplace the transaction is to occur in, and the participant requesting the market transaction. Trade-credit apparatus interfacing subprocessor 152 receives market transaction object 151 and interfaces with trade-credit exchange apparatus 100 to place the order therein. If the order is executed then trade-credit apparatus interfacing subprocessor 152 completes a transaction of exchanging the items offered for the items demanded, by appropriately updating participant holding object 75f within resource database 70.

In other embodiments the tokens may be used as a common exchange medium in other markets. Those other markets comprise established exchanges other than the trade-credit exchange apparatus.

As illustrated in exemplary embodiment shown in FIG. 1, participant 110f, using interface 115f, generates market transaction object 151 containing properties comprising the items offered, the items demanded the specific marketplace the transaction is to occur in, and the participant requesting the market transaction. External exchange interfacing subprocessor 153 receives market transaction object 151 and interfaces with other markets 90 to place the order therein. If the order is executed then external exchange interfacing subprocessor 153 completes a transaction of exchanging the items offered for the items demanded, by appropriately updating participant holding object 75f within resource database 70.

In other embodiments the tokens may be used as a common exchange medium for token transactions between members that have nothing to do with interacting with the asset-pool.

As illustrated in exemplary embodiment shown in FIG. 1, participant 110f, using interface 115f, generates market transaction object 151 containing properties comprising the items offered, the items demanded the specific marketplace the transaction is to occur in, and the participant requesting the market transaction. Participant market subprocessor 154 receives market transaction object 151 and interfaces with other markets 90 to place the order therein. If the order is executed then participant market subprocessor 154 completes a transaction of exchanging the items offered for the items demanded, by appropriately updating participant holding object 75f within resource database 70.

It should be noted that various changes and modifications to the presently preferred embodiments described herein will be apparent to those skilled in the art. Such changes and modifications may be made without departing from the spirit and scope of the present invention and without diminishing its attendant advantages.

I claim:

1. An asset-backed token processing apparatus comprising:
a controller;
a memory coupled to the controller, wherein the memory is configured to store program instructions executable by the controller;
wherein, in response to executing the program instructions, the controller is configured to:
generate a quantity of fungible tokens at a fixed rate in response to a receipt of a quantity of an asset in a first category of assets from a remitter, wherein the quantity of fungible tokens generated includes a quantity of tokens provided to the remitter and a quantity of fungible tokens available to be auctioned;
auction the fungible tokens available to be auctioned in exchange for the remittance of a quantity of an asset in a second category of assets, wherein the remittance rate of the asset in the second category of assets is a variable, bid-driven rate determined by the auction;
redeem the remitted quantity of the assets in the first category of assets for fungible tokens at a variable, bid-driven rate, wherein the variable, bid-driven rate at which the remitted assets in the first category of assets are redeemed must be at or above a minimum required rate, wherein a quantity of the fungible tokens used in the redemption of the remitted assets in the first category of assets equal to the minimum required rate are eliminated and any remaining quantity of the fungible tokens used in the redemption of the remitted assets in the first category of assets are provided to the remitter; and
redeem the quantity of the remitted assets in the second category of assets for fungible tokens at a rate defined by the average of the one or more variable, bid-driven rates determined by the one or more auctions in which assets in the second category of assets have been remitted, wherein the fungible tokens used in the redemption of the quantity of the remitted assets in the second category of assets are eliminated.

2. The asset-backed token processing apparatus of claim 1 wherein the assets in the first category of assets are labor-time assets.

3. The asset-backed token processing apparatus of claim 2 wherein the assets in the first category of assets pledged are a quantity of time for which the remitter will provide labor.

4. The asset-backed token processing apparatus of claim 1 wherein the controller does not limit the remittance of assets in the first category of assets from the remitter.

5. The asset-backed token processing apparatus of claim 1 wherein the quantity of fungible tokens available at auction is a function of the quantity of fungible tokens provided to the remitter.

6. The asset-backed token processing apparatus of claim 5 wherein the quantity of the fungible tokens available at auction is fixed and the quantity of fungible tokens provided to the remitter is fixed.

7. The asset-backed token processing apparatus of claim 5 wherein the function is a one-to-one ratio.

8. The asset-backed token processing apparatus of claim 1 wherein the quantity of the assets in the first or second category of assets received at auction may be exchanged for a quantity of an asset in a different category of assets, wherein the exchange rate is a variable, bid-driven rate determined by an exchange auction.

9. The asset-backed token processing apparatus of claim 1 wherein the assets in the first category of assets are non-fungible assets and the assets in the second category of assets are fungible assets.

10. The asset-backed token processing apparatus of claim 1 further including a third or greater category of assets subject to the same remittance and redemption criteria required for the second category of assets.
